(19) United States
(12) Patent Application Publication
(10) Pub. No.: US 2014/0188690 A1
(43) Pub. Date: Jul. 3, 2014

(54) USER DEFINED NET TICK VOLUME BARS

(71) Applicant: Robin Mitchell, Carlsbad, CA (US)

(72) Inventor: Robin Mitchell, Carlsbad, CA (US)

(21) Appl. No.: 14/146,183

(22) Filed: Jan. 2, 2014

Related U.S. Application Data
(60) Provisional application No. 61/748,212, filed on Jan. 2, 2013.

(51) Int. Cl. G06Q 40/04; G06F 3/0484

(52) U.S. Cl. CPC G06Q 40/04; G06F 3/0484
USPC 705/37

(57) ABSTRACT

The present invention relates to the field of computer implemented price and volume charting in the stock, commodity, futures, options and other markets, as well as the use of a computer to process various trading volume information to define the interval or duration of a price bar.

### CROSS-REFERENCE TO RELATED APPLICATIONS

This application claims the benefit of the following provisional application, each of which is hereby incorporated by reference in its entirety: U.S. Pat. App. No. 61/748,212 filed on Jan. 2, 2013 and entitled “User Defined Net Tick Volume Bars.”

### FIELD OF THE INVENTION

The present invention relates to the field of computer implemented price and volume charting in the stock, commodity, futures, options and other markets, as well as the use of a computer to process various trading volume information to define the interval or duration of a price bar.

### BACKGROUND OF THE INVENTION

Traditional means for displaying volume and volume related price bars on financial and other charts is inadequate for analyzing an upward or downward bias in the markets. Markets are driven by volume and cannot go anywhere without it, yet, the only volume data that is used in the construction of price bars in the industry is total volume. Some exchanges put out other volume data such as tick data or bid/ask data that can be parsed out in terms of its directionality (i.e. buy or sell related volume).

Charting packages that are available through any number of vendors can provide you with real time volume data that can be used to tell the user in which direction the volume is moving or what its trend might be. However, this data cannot be put on a price chart in such a manner that directly correlates it to price movement (up or down). For example, it does not show you if the buyers are overwhelming the sellers (or visa-versa), in the interval of the price bar.

There are a number of types of volume in use. One is tick volume. In this scheme, the software will make a count of the number of times the stock price moves up or down in an interval, and can report that count. Some software packages will parse the data out in terms of up and down ticks, many do not. However, if you go down to the tick (most detailed) level in the data that is provided by various data vendors, you can often get volume data that can be used to construct (a new composite or type of) volume data that shows the up/down bias relationship. As mentioned, this processing does not relate to specific price bars or charting types. From this most detailed level of data you can establish a starting point from which you can construct or compute up or down tallies of tick and or bid/ask volume data. For the purpose of this document, both tick volume and bid/ask volume will be referred to as volume since both types and the various permutations of such volume data apply to this discussion equally. There are various types of volume that will be described in more detail herein.

As mentioned, it is possible to access the data from the data vendor at the tick (highest) level of resolution and extract various data and organize it into up biased and down biased volume (or ticks), which with further computations can help one to determine the directional bias in a market's volume (or ticks). From there, one could plot the data in a chart in order to analyze how specific price fluctuation is occurring with respect to volume changes. Since price moves only up and down, it would also make sense to parse the data out in a manner that would make it possible for one to correlate, through various processes, this up or down biased data (volume) with corresponding movements in price. To take it a step further, it would be very beneficial to plot the individual price bars per the bias of various units of up or down volume or ticks over the interval of a bar. In order to do this, one would, for example, simply allow a bar to function and plot according to its specific rules for doing so, until a certain user input quantity of volume (tick or volume) was reached. This could be done with a specific unique process (as will be described herein) and would allow, for example, the user to correlate specific movements in price to specific units of volume moving in the corresponding direction.

Existing price bars developed and offered by vendors in the last 150 years are based on a data organization scheme such as by time (where each new bar is a set time interval), price range (where each bar is a set price range such as 1 point of price movement), volume (where each bar is a fixed amount of total volume), or ticks (where each bar is a set number of total movements in price called ticks), etc. Although tick bars are a type of volume bar, there is simply no way currently to chart or graph a price bar that is based on a specific up or down volume or tick movement in a manner that is directly related to price movement. Many vendors of charting packages enable users to program various computations or set parameters onto their price charts, however, due to the fact that this particular sort of computer programming is internal to the software, even the multiple degrees of freedom and latitude of customization provided by the charting packages are unable to allow end users to produce this type of custom price bar. Certain charting package vendors have various “Partners” who may be computer programmers or “Developers” who may have this capability (the capability of doing internal programming), but no solution exits that would allow vendors to implement this approach internally.

Therefore, there is a need in the art for a charting and graphing solution for use in financial markets that allows for a user to customize the parameters of a pricing chart to more accurately track and predict trends in the market. These and other features and advantages of the present invention will become obvious to one skill in the art through the summary of the invention that follows.

### SUMMARY OF THE INVENTION

The present invention comprises computer implemented methods and systems to create and display User Defined Net Tick/Volume Bars (UDNTVBs). In some embodiments, UDNTVBs are price bars electronically displayed on a financial chart with a user defined set value that will determine the amount of net buying or selling that defines the interval of a price bar. This will cause the interval of the bar and the price range of the price bar to vary based on net volume as defined below.

In some embodiments, there are two types of volume that may be used in the process of making UDNTVBs and within these two types, there are other measures that may be used (as will be described herein). These two types are known as Bid/Ask volume and tick volume. Bid/ask volume applies to actual filled orders for the underlying commodity, futures, or stock, etc. Tick volume applies to up and down movements (called “ticks”) in price in the underlying where upward movements are considered buying volume or pressure and downward movements are considered to be selling volume or pressure. Both apply to this discussion. Net volume is directional as it shows specifically where one type of volume, buying or selling volume, is overwhelming the other side. This way of processing the volume therefore causes it to have a directional bias; positive (on net up volume) or negative (on net down volume), that is directly related to the price movement within the interval of the created price bar.

According to an embodiment of the present invention, a system for plotting price bars on a price chart for a financial instrument, includes a bar plotting module, comprising computer-executable code stored in non-volatile memory, a processor, and a communications means, wherein the bar plotting module, the processor, and the communications means are operably connected and are configured to: receive a volume threshold for a user, wherein the volume threshold is a threshold value for beginning a new user defined net tick volume bar, receive one or more market trading information parameters, wherein the one or more market trading information parameters is selected from a group of market trading information parameters comprised of price data, tick data, volume data, and time interval data, determine volume-price change association, wherein an up volume-price change association indicates increased buying activity and a down volume-price change association indicates increased selling activity, analyze one or more market trading information parameters, wherein an incoming volume change is calculated based at least on a change in the volume data, calculate updated bar volume, wherein the updated bar volume is based on current bar volume and the incoming volume change, determine if the updated bar volume exceeds the volume threshold, wherein if the updated bar volume is less than the volume threshold an existing user defined net tick volume bar is updated to reflect current price data and the updated bar volume, wherein if the updated bar volume exceeds the volume threshold the new user defined net tick volume bar is generated to display one or more volume bar information factors selected from a group of volume bar information factors comprising uptick trades, uptick volume, downtick trades, downtick volume, volume at ask trades, volume at ask volume, and volume at bid trades, and volume at bid volume, plot the new user defined net tick volume bar on a chart, wherein the new user defined net tick volume bar is displayed to a user.

According to an embodiment of the present invention, the one or more market trading information parameters are received from a source of real time market data.

According to an embodiment of the present invention, the one or more market trading information parameters are received from a source of archived market data.

According to an embodiment of the present invention, the new user defined net tick volume bar is displayed as an open-high-low-close style bar.

According to an embodiment of the present invention, the new user defined net tick volume bar is displayed as a candlestick style bar.

According to an embodiment of the present invention, method for plotting price bars on a price chart for a financial instrument, the method including the steps of: receiving a volume threshold for a user, wherein the volume threshold is a threshold value for beginning a new user defined net tick volume bar, receiving one or more market trading information parameters, wherein the one or more market trading information parameters is selected from a group of market trading information parameters comprised of price data, tick data, volume data, and time interval data, determining volume-price change association, wherein an up volume-price change association indicates increased buying activity and a down volume-price change association indicates increased selling activity, analyzing one or more market trading information parameters, wherein an incoming volume change is calculated based at least on a change in the volume data, calculating updated bar volume, wherein the updated bar volume is based on current bar volume and the incoming volume change, determining if the updated bar volume exceeds the volume threshold, wherein if the updated bar volume is less than the volume threshold an existing user defined net tick volume bar is updated to reflect current price data and the updated bar volume, wherein if the updated bar volume exceeds the volume threshold the new user defined net tick volume bar is generated to display one or more volume bar information factors selected from a group of volume bar information factors comprising uptick trades, uptick volume, downtick trades, downtick volume, volume at ask trades, volume at ask volume, and volume at bid trades, and volume at bid volume, plotting the new user defined net tick volume bar on a chart, wherein the new user defined net tick volume bar is displayed to a user.

According to an embodiment of the present invention, the one or more market trading information parameters are received from a source of real time market data.

According to an embodiment of the present invention, the one or more market trading information parameters are received from a source of archived market data.

According to an embodiment of the present invention, the new user defined net tick volume bar is displayed as an open-high-low-close style bar.

According to an embodiment of the present invention, the new user defined net tick volume bar is displayed as a candlestick style bar.

A vendor could implement this invention by putting it into their existing software's bar type schemes. Organizing data in the manner of UDNTVBs gives the viewer/user the ability to see direct cause and effect relationships between the various forms of the volume associated with price movement and the price movement itself.

This invention is needed because it is important to traders to be able to determine the trend (sustained directionality) of the market. Much of the time, the market is in consolidation. Traders who get trapped in markets that are not moving or are consolidating typically lose money. If a trader can determine, even with a small advantage, if a market is trending or not trending, it can make a huge difference in their end result (i.e. profitable vs. not profitable). UDNTVBs produce fewer bars while the market is in congestion (inactive) and more bars when it is moving or trending (active). Since charts made up of UDNTVBs will result in different chart geometry through the resulting expansion and contraction of the chart's X axis and corresponding price ranges, it provides the user with a deeper level of analysis than is otherwise not available. Put another way, this invention, in some embodiments, causes changes in the time axis of charts that makes the resulting plots unique. This is due to the duration or interval of bars themselves, the price range of the bars, and the expansion and contraction of the time axis. This varying of the X axis results in a varying of the vertical or price movement of the underlying commodity or stock, financial instrument, etc. This variance in both axes, results in a completely unique plot.

Further, UDNTVBs can help traders to identify this X-Y variance not only by analyzing the bigger structure of price movement, but within the individual bars themselves. For this reason, they are superior to other types of bars. This is true not just by opinion, but statistically (as will be shown herein). This is true because the very structure of UDNTVBs is tied to the forces that move markets up and down (volume) and there is a cause and effect relationship between price movement and the directional volume that makes up these bars (as will be shown herein). Therefore, a) Traders need and can substantially benefit from UDNTVBs, b) they are unique and superior to other types of available bars, and, c) they are discernibly unique when comparing them to other available bar types/charts.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

The drawings represent two examples of styles of presenting price bars. Both FIG. 1 and FIG. 2 represent the same price data but with a different style of presentation.

FIG. 1 illustrates a typical Open High Low Close Bar (OHLC). This style of bar has tick marks on the left and right side of the bars. The left tick mark represents the open or beginning of the bar. The right most tick mark represents the close or end of the bar. Multiple bars together are called a chart;

FIG. 2 illustrates a typical candlestick chart. This style of bar chart represents the open and close of the bar by black and white colored boxes. The color will be enclosed by a boxed area. The level of the top and bottom of the box are the open and close of the bar. White bars mean within that bar the close price is higher than the open price, while black bars mean within that bar the close price is lower than the open price;

FIG. 3 illustrates a candlestick bar whose High is equal to the close of the bar. This tendency is a characteristic feature of UDNTVBs in a data stream or chart that is trending upward;

FIG. 4 illustrates what a candlestick bar whose Low is equal to the Close of the bar. This tendency is a characteristic feature of UDNTVBs in a data stream or chart that is trending downward;

FIG. 5 illustrates what a candlestick bar whose Low is the open and close is the High of the bar. This tendency is a characteristic feature of UDNTVBs in a data stream or chart that is trending strongly upward;

FIG. 6 illustrates what a candlestick bar whose High is the open and close is the Low of the bar. This tendency is a characteristic feature of UDNTVBs in a data stream or chart that is trending strongly downward;

FIG. 7 illustrates UDNTVBs on a bar chart in the candlestick style of plotting bars over the same interval of time as charts/FIGS. 8-11. The chart is a chart comprised of UDNTVBs;

FIG. 8 illustrates Volume Bars on a bar chart in the candlestick style of plotting bars over the same interval of time as FIGS. 7 and 9-11;

FIG. 9 illustrates Ticks bars on a bar chart in the candlestick style of plotting bars over the same interval of time as FIGS. 7-8 and 10-11;

FIG. 10 illustrates Time based bars on a bar chart in the candlestick style of plotting bars over the same interval of time FIGS. 7-9 and 11;

FIG. 11 illustrates Range based bars on a bar chart in the candlestick style of plotting bars over the same interval of time as FIGS. 7-10;

FIG. 12 illustrates a detail of the downward trending interval from approximately the beginning of the trading day to the Low just after 7 AM on FIGS. 7-10. This is done to compare the charts over this interval of time. It is also called Interval A;

FIG. 13 illustrates a detail of the upward trending interval from approximately just after 7 AM to the High around 7:21 AM on FIGS. 7-10. This is done to compare the charts over this interval of time. It is also called Interval B;

FIG. 14 illustrates a detail of the downward trending interval from approximately the 7:22 AM to the Low just before 7:40 AM on FIGS. 7-10. This is done to compare the charts over this interval of time. It is also called Interval C;

FIG. 15 illustrates a detail of the upward trending interval from approximately just after 8:20 AM to the High around 9:15 AM on FIGS. 7-10. This is done to compare the charts over this interval of time. It is also called Interval D;

FIGS. 16A-C illustrates statistics compiled from the analysis of the intervals in FIGS. 12-15 (Intervals A-D) in order to show the consistency and validity of UDNTVBs compared to the other bar types in the intervals tested. It also summarizes the percentage of the time the given criteria is met;

FIG. 17 illustrates a flow chart displaying one example of a computer implemented process used in the construction of UDNTVBs;

FIG. 18 illustrates a schematic overview of a computing device, in accordance with an embodiment of the present invention;

FIG. 19 illustrates a network schematic of a system, in accordance with an embodiment of the present invention; and

FIG. 20 illustrates a schematic of a system in accordance with an embodiment of the present invention.

### DETAILED SPECIFICATION

User Defined Net Tick/Volume Bars (UDNTVBs) are price bars used in charting graphing system whose duration is determined by a process that is based on a directional bias (up or down) of volume or tick data (price data, tick data, volume data, and time interval data, collectively “market trading information”). Price movement in a stock, commodity or similar financial instrument cannot occur without underlying buy and sell orders. It is these underlying buy and sell orders that move price up or down. Buy orders and associated order size are correlated with upward movement in price. Sell orders and associated order size are correlated with downward movement in price. No current form of charting specifically relates this underlying buy/sell pressure to up and down price movement. There are three types of existing price bar types that are currently in existence for use in charting packages: time based bars, range based bars and total volume based bars. None of these bar types relate upward or downward price movement that occurs within the price bar's interval to the corresponding net buying or selling that specifically caused such price movement. UDNTVBs were designed specifically for this purpose. UDNTVBs are unique and provide the user an advantage in analyzing price movements in a manner that specifically relates to supply and demand forces in the market place.

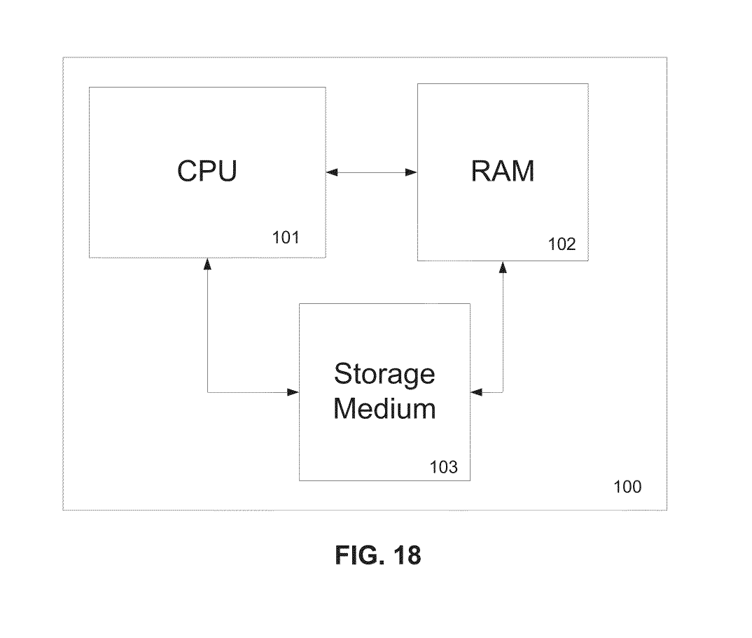

According to an embodiment of the present invention, the system and method is accomplished through the use of one or more computing devices. As shown in FIG. 18, one of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smartphones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

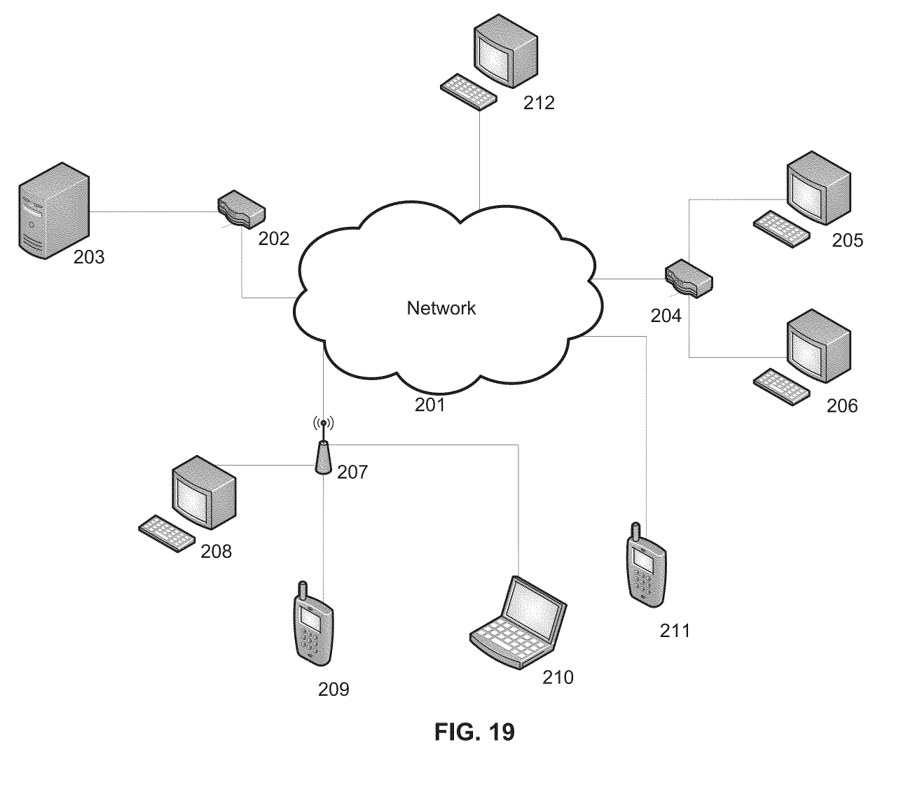

Referring to FIG. 19, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a Network 201 (e.g., the Internet, a LAN, WiFi, Bluetooth, etc.). Applications in server 203 may also be used to manipulate information stored remotely and process and analyze data stored remotely across a Network 201 (e.g., the Internet, a LAN, Wi-Fi, Bluetooth, etc.).

According to an exemplary embodiment, as shown in FIG. 19, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via Network 201 or other network in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

In a preferred embodiment of the present invention, the system is comprised of one or more servers configured to manage the transmission and receipt of content and data between users and recipients. The users and recipients may be able to communicate with the components of the system via one or more mobile computing devices or other computing device connected to the system via a communication method supplied by a communication means (e.g., Bluetooth, WIFI, CDMA, GSM, LTE, HSPA+).

In order to proceed in sufficient detail, we must define the following terms: 1) Bar Style; 2) Interval, Duration or Bar Type; and 3) Volume.

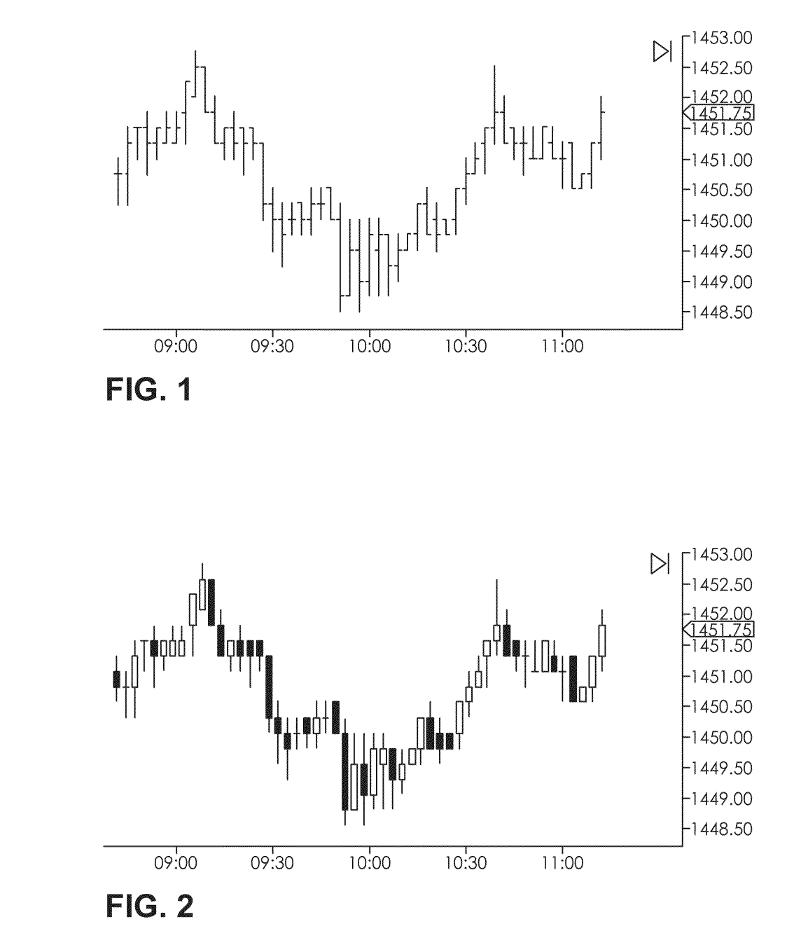

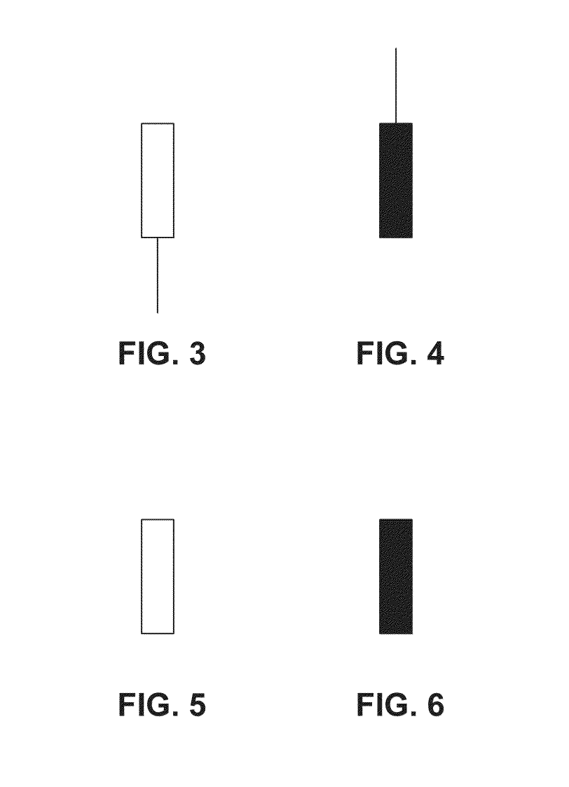

On the type of financial chart known as the bar chart, there are several ways of plotting data that are available in charting packages (software) that are applicable to our discussion. The bar style might be a dot at close in the XY Cartesian field of the chart. The close is the last or final point in a given interval or bar. Another style would be to draw a line from close to close. From here there are plots that involve what are called bars. Bars are a manner of summarizing data in an interval. These bars typically have four components (Open, High, Low and Close) and are often called OHLC bars (see FIG. 1), where the Open is the beginning of the interval for a bar; the Close is the end of the interval; and the High and Low are the range extremes inside the interval. These styles of bars are one example of bars which may be used with the present invention. There is another style of bar called a Candlestick bar (see FIG. 3). This is a form of an OHLC bar but where the open and close region of the bar is boxed (see FIGS. 3-6). If the movement between the open and close is up, then the bar is colored white (or typically green in charts featuring color) (FIGS. 3 and 5) and if the open to close relation is down, then the bar is colored black (or typically red in charts featuring color) (FIGS. 4 and 6). The present invention may use, for example, candlestick bars or OHLC bars (FIGS. 1 and 2 show what these style of bars might look like). The word “style” applies to the above types of bars on charts.

Next we need to define the term interval, duration or bar type as it applies to various existing and possible bar types. As used herein, the term interval may mean either the amount of time the bar lasts or a given amount of a value such as volume. For example, a bar can be constructed in the interval of seconds of time, 1 minute, 60 minutes, a day, week or month. Any interval in time may be used. A bar constructed based on a time interval (like a 5-minute chart) will be plotted at a fixed frequency of time (or equal amount of time) on the X-axis. Then, there are also bars whose interval is based on price range. In this case, when the bar exceeds a certain price range (High−Low=range) then a new bar will commence. Even though time is plotted on the X-axis, this sort of bar will not be plotted at a fixed interval of time since the time it takes to achieve a certain set range of price will vary. Next and finally, there are bars based on volume. These bars will plot based on the amount of total volume that has transpired (this includes either tick volume or total volume). When the specified amount of total volume has passed from the commencement of a volume bar, then the current bar will close and a new bar will then commence. This type of bar, similarly to a bar that has an interval on price range, will not be plotted at fixed time interval in the X-axis because the time it takes to achieve/reach a certain set total volume will vary. In alternate embodiments, different bar types or bar duration determinants may be used. Furthermore, certain bar types may incorporate multiple bar duration determinants into one type of price bar. One of ordinary skill in the art would appreciate that there are many bar types and bar duration determinants that may be used by the present invention, and embodiments of the present invention are contemplated for use with any such bar type or bar duration determinants.

There are a number of types of volume which may be shown on a price chart. The above paragraph describes a specific type of total volume. Charting packages will plot such volume bars based on total volume or total tick volume. Sometimes volume bars are called share bars (referring to shares of stock that have traded at the bid and ask prices known as market orders). Total volume is the amount of volume that is traded inside a set interval of price or time. This is reported by the various exchanges and it is not uncommon to see volume on charts say on Google Finance or Yahoo finance with volume plotted in the bottom of the chart. Then there is tick volume. There was a time when the exchanges did not provide timely volume data. As a result, traders tried to approximate the actual volume by counting “ticks” or price movements. Each time the price moves, the tally of ticks is incremented and from this you can have a tick count inside an interval and you can construct price bars based on a set number of such ticks or volume. Both of these types of volume apply to UDNTVBs.

There are various other ways one could compute volume. The first distinction to make here is between trades and volume. A trade is like a line entry in an accounting. You would count only the fact there was a transaction, but without regard to the size of the transaction. This is a “Trade”, but it does not take into account the size (number of shares for example) of that trade. When we use the term Volume, we are talking both about the Volume (actual size, e.g. number of shares) of the trade and line entry. So, from here, we can distinguish between tick volume, trades, and volume as this invention covers all the above. Actual trades in this system of accounting can either occur at the bid or ask price in the market's auctioning process. We could further distinguish upward and downward oriented volume (both tick and volume), in terms of this. For ticks they would be called upticks or downticks (trade or volume) and for actual trades, we would have volume or trades at the bid or ask. The bid is trades or volume associated with downward price movement. The Ask is trades or volume associated with upward movements in price. For the purpose of our discussion, the term Volume may refer to all the above described type of volume whether it be ticks trades, tick Volume, Bid/Ask trades, Bid/Ask Volume, uptick trades, uptick volume, downtick trades, downtick Volume, Volume at Ask Trades, Volume at Ask Volume, Volume at Bid Trades, Volume at Bid Volume, etc. (collectively, “volume bar information factors”). Currently available charting packages do not allow for creating bars based on these types of volume or computations created from them. All these types of volume apply to UDNTVBs.

Having laid the groundwork, we can now begin the discussion of User Defined Net Tick/Volume Bars. According to a preferred embodiment of the present invention, UDNTVBs use the above stated forms of volume in various permutations in order to define the interval of a price bar.

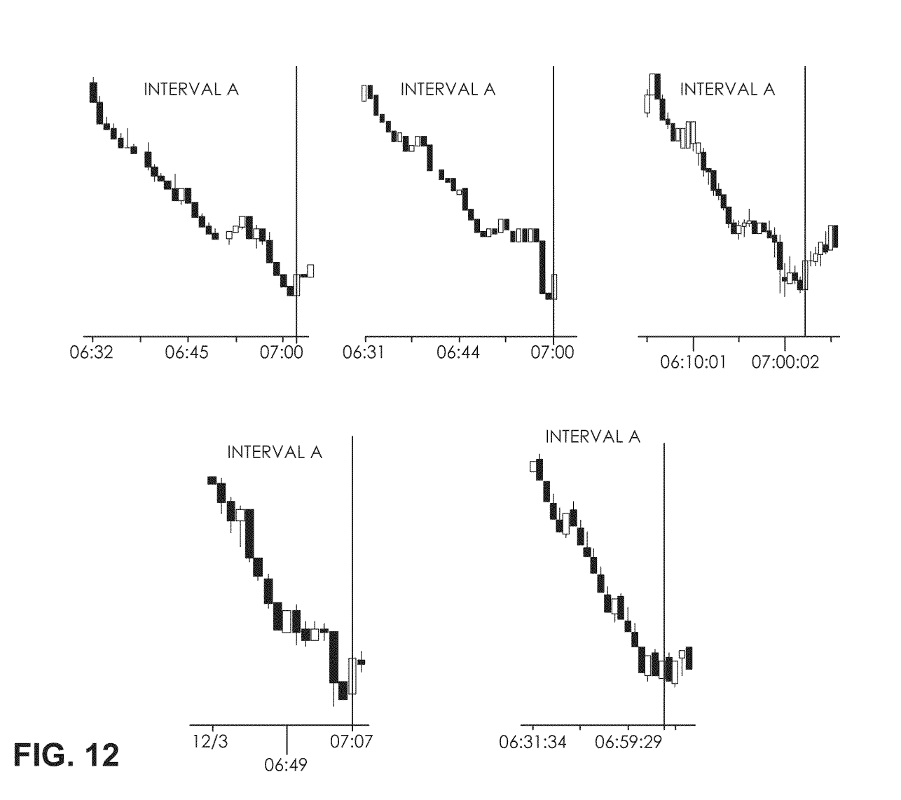

The two charts (FIGS. 1 and 2) show some non-limiting examples of UDNTVBs charts according to various embodiments of the present invention. UDNTVBs may be indistinguishable to someone viewing a price chart as the style of plotting (OHLC or candlestick etc) will dictate the overall look. However, when compared to other types of price charts over the same interval, UDNTVBs will vary considerably as to what is displayed along the X axis of the graph (time) and Y axis of the graph (range). According to a preferred embodiment of the present invention, the primary difference is that the bars will be in a sequence and interval in time and volume (or tick counts) that will vary from any other current type of bar in existence. Therefore, when a UDNTVB chart is compared to another form of price chart (e.g. minute bars or tick or volume bars), the two plots will look different because the overall shape of each chart will be different due to the varying methods used to create two different charts. In the preferred embodiment, the resulting UDNTVB chart bars will enable the user to identify relationships between volume of all sorts (i.e. buy and sell pressure) and correlate it specifically to the quantity (number of bars in time) and price ranges (height of bars over a specific amount of net volume of net ticks). In contrast to the present invention, existing bars and plotting techniques, as previously mentioned, will only show relationships between price and time or relationships between total volume (or ticks) and price. As an illustrative example, FIGS. 12 through 15 show examples of different plotting methods lead to a varying visual presentation between UDNTVB charts and other charts, despite the fact that each chart is plotting the same interval.

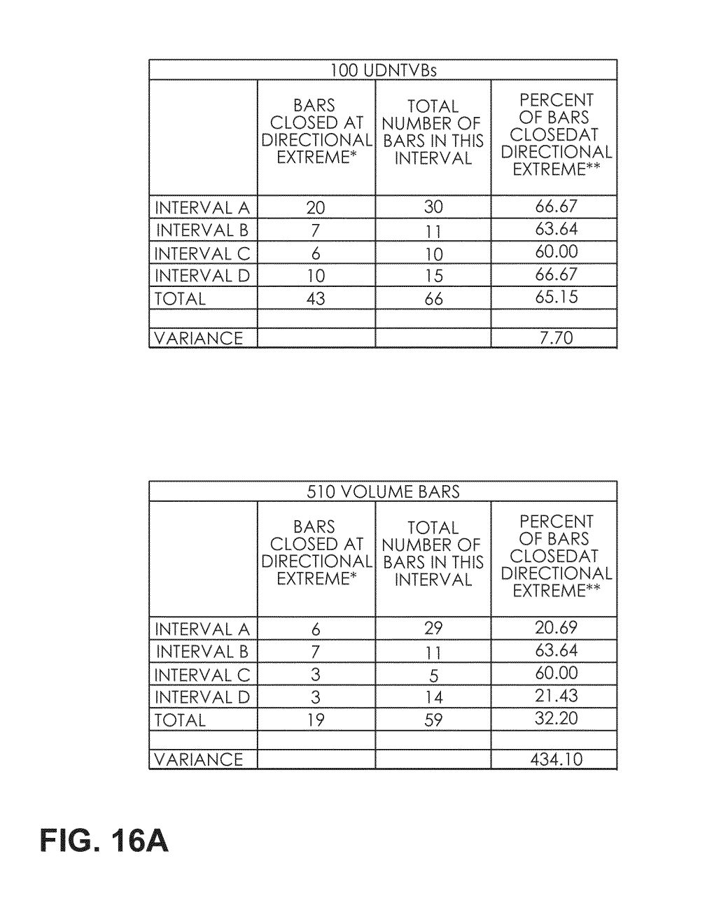

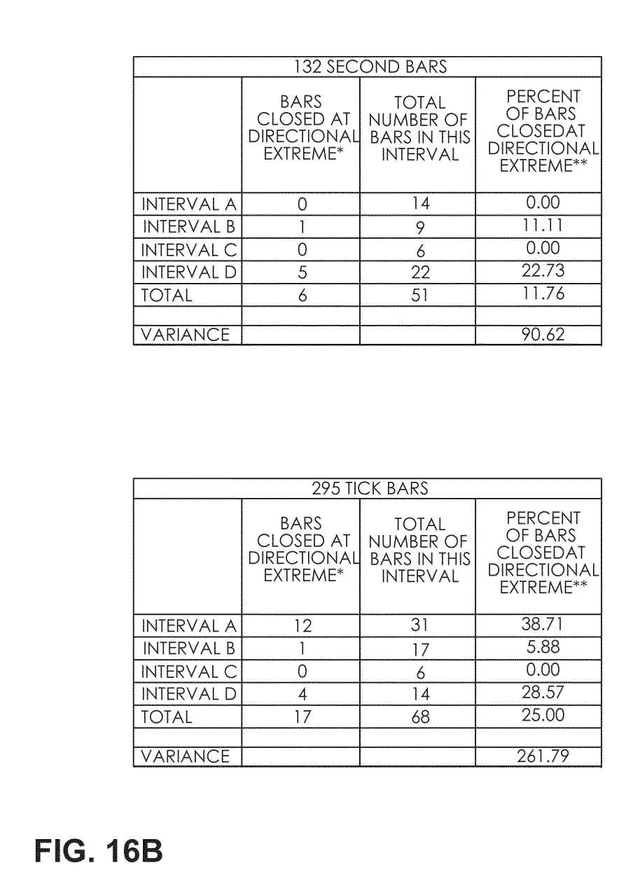

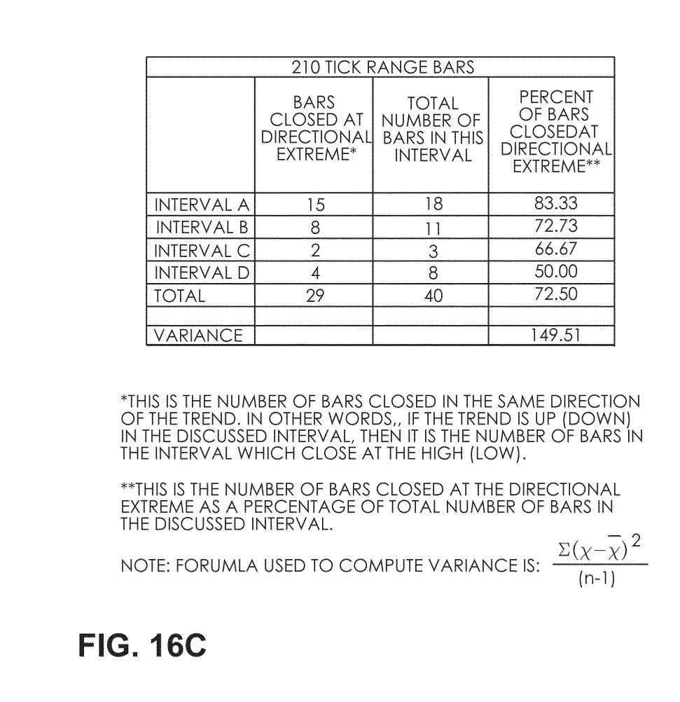

In order to illustrate an example of how UDNTVBs will vary the X and Y axis of the resulting chart, we need to understand first that this will be occurring in two dimensions. One as the overall look of the graph itself. Secondly, the individual bars themselves will look different. Illustrative examples provided below will show differences in the individual bars and summarize the statistics of such results in the table in FIGS. 16A-C. These examples will also show that UDNTVBs will, in some embodiments, generate more bars when the market is trending (moving directionally) than other types of bars while exhibiting characteristics of greater smoothness and consistency.

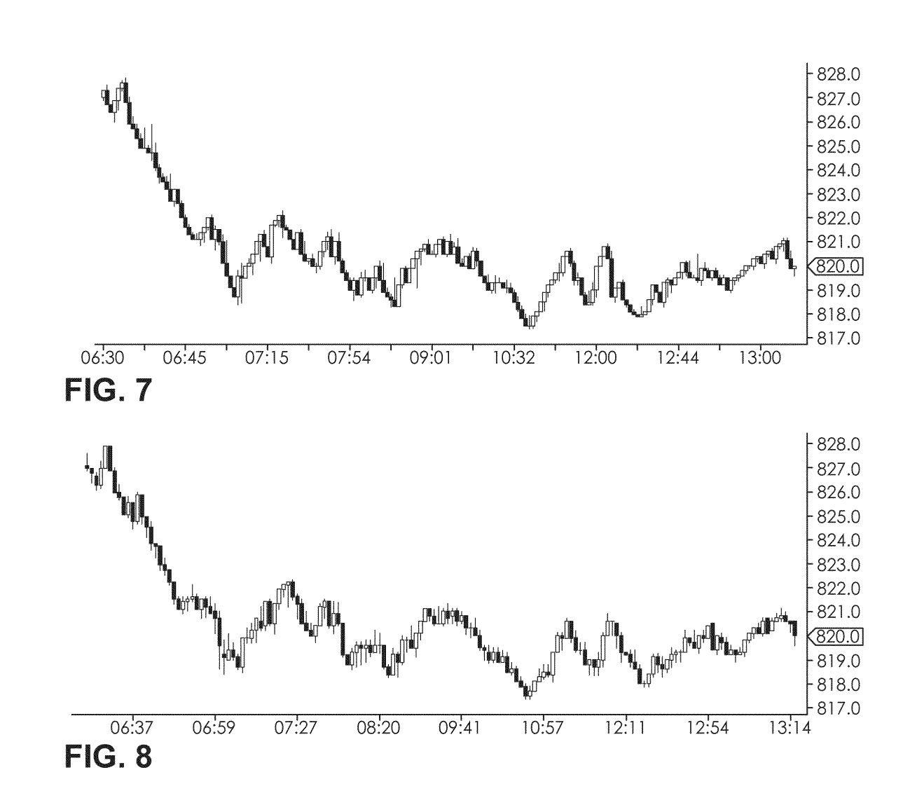

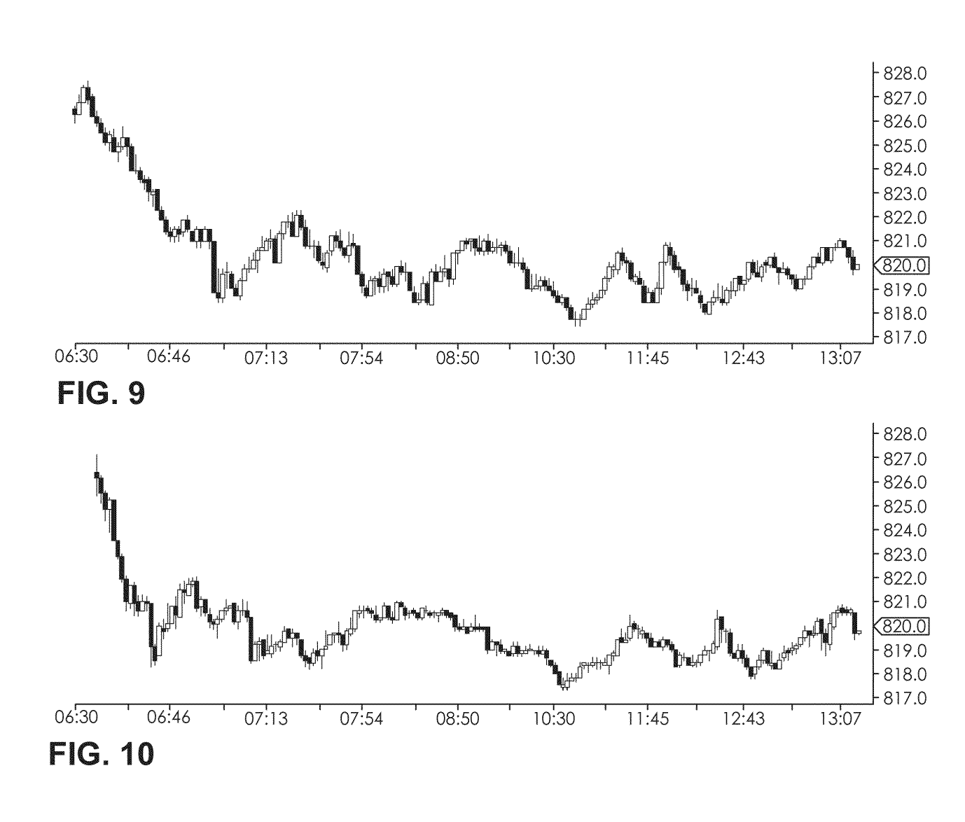

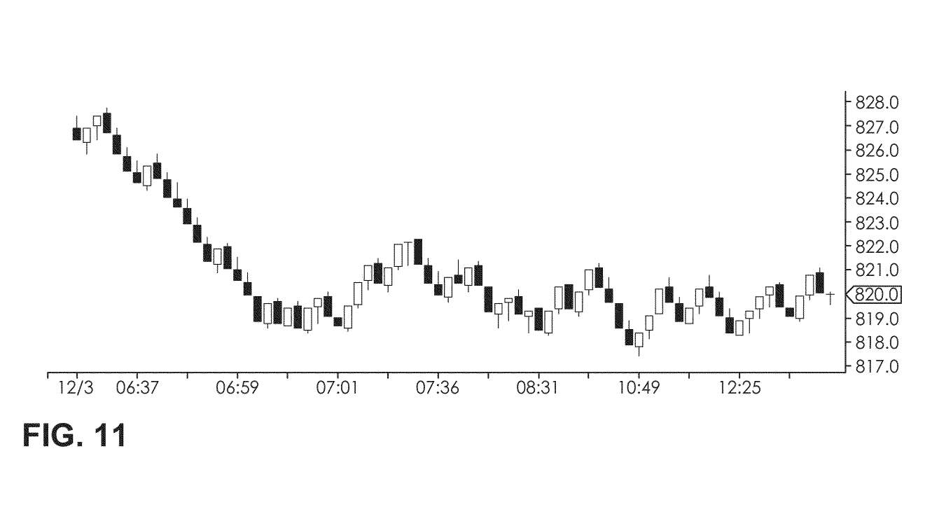

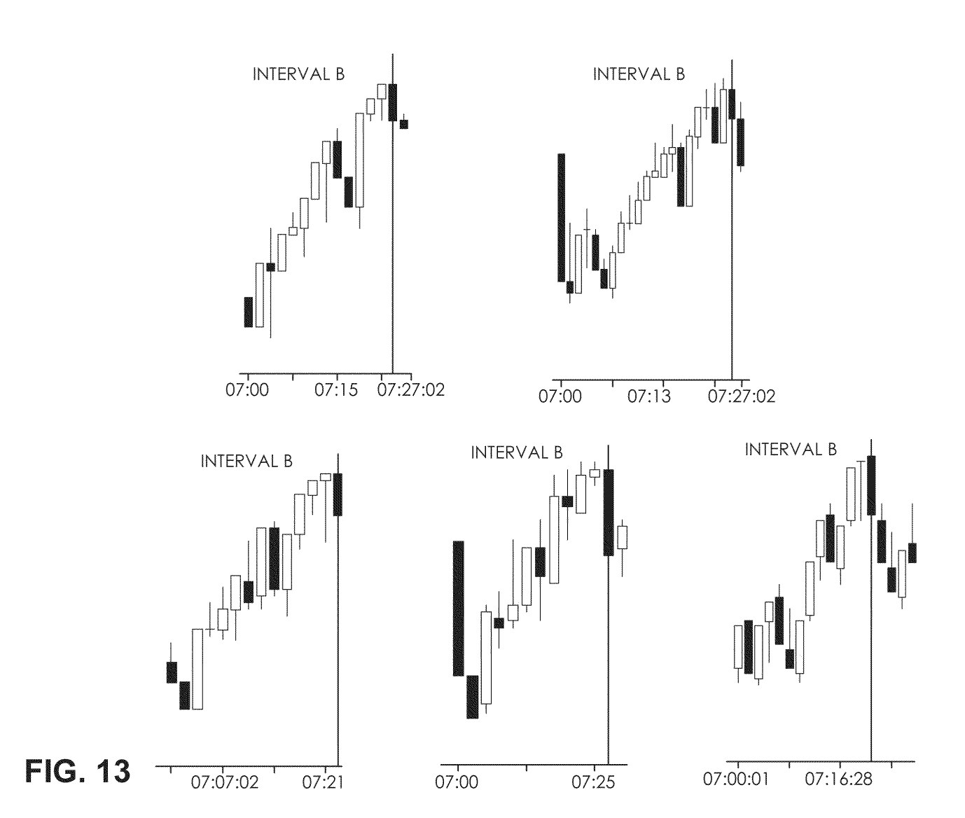

Turning now to FIG. 12, an illustrative example of an embodiment of the present invention. Inside Interval A, the market moved downward from the open of the trading session to the Low just after 7 AM. The UDNTVB chart (as shown in FIG. 7, as well as the leftmost chart in FIGS. 12-15), is our reference in this interval to the other charts over the same interval. It is important to note that with the exception of the rightmost chart, which is a fixed range chart, the other charts show substantially elongated bars right before 7 AM. This is an example of an elongated Y-axis component in other types of charts. This concept is also illustrated when comparing the entirety of FIGS. 7-11, as shown in the other intervals that are the focus of FIGS. 13-15). The other bar charts (i.e. FIGS. 8-11) are essentially only showing that there was expanding price movement per unit of total volume or time.

According to an embodiment of the present invention, the UDNTVBs smooth the vertical or Y-axis movement, which results in more bars plotted within the same corresponding price movement in the same time interval. In the preferred embodiment, when a chart is plotted with UDNTVBs, the X-axis is no longer divided by fixed unit of time, but is plotted at whatever time resulted from the biased directional component of the price/direction UDNTVBs vector. Furthermore, UDNTVBs not only show the expansion in total volume like some of the other bar types, but may further show that within the price expansion there exists directional volume which moved price lower in a more consistent fashion. As a result, the UDNTVBs (leftmost chart) generated a similar number of bars overall in FIG. 12 (Interval A) when compared to the total tick or total volume bars (second and third charts from the left) but did so more smoothly (i.e. no particularly tall bars). On the other hand, the UDNTVBs generated an increased number of bars overall when compared to the time based bars (the two rightmost charts). In all cases, the UDNTVBs based plotting method generated a smoother graph than any of the other plotting methods. It is also important to note that the range bars (the right most chart in FIG. 12-15) also appears to be quite smooth because the range bars are of fixed height (price range), therefore their plot will be made of consecutive fixed vertical price movement with no regard to the amount of time or volume associated with that movement of price range. Range bars will by definition, also close at their High or Low, while UDNTVBs will not only do so but will do so specifically when the market is trending thereby offer users both the magnitude and directional bias of the market.

Before continuing into more detail as to unique characteristics of UDNTVBs plots, it is important to detail the process methodology behind the UDNTVB based bars and what makes the UDNTVB bars work the way they do. This will provide a foundation to more easily understand the examples that are presented throughout this disclosure, as well as showing the basis which makes the UDNTVB plotting method unique.

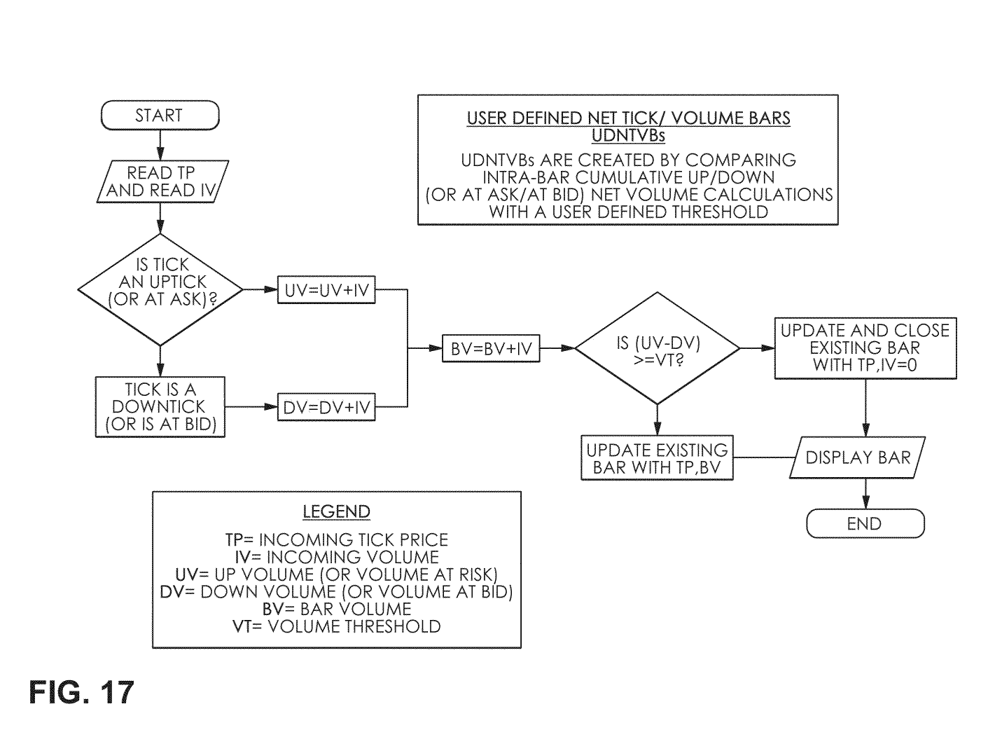

Turning now to FIG. 17, a process flow chart for creating a UDNTVB bar in accordance with an embodiment of the present invention. The UDNTVB bars may be derived from different types of volume data described more fully elsewhere within. First, the bar plotting module initially reads the volume and price data. Next, the bar plotting module makes a determination as to whether the volume associated with the price change is up (increased buying activity) or down (increased selling activity) oriented (i.e. volume-price association). In practice, this could be trades that have occurred at bid or at the ask price or simply upward movements or downward movements in price. Each may be further broken down into alternate units, including but not limited to actual volume or counted as line entries. In any case the directionality is determined and a running count is made of each. This is shown in the formulas UV (up volume)=UV+IV (incoming volume) and DV (down volume)=DV+IV (incoming volume). A running total is then computed based on the resulting directional volume. Subsequently, a test is made to see if the directional volume count has reached the absolute value of the input by the user. If it has not, the process will continue. If it has met the threshold as defined or specified by the user, then the process will commence a new bar. Finally, the process displays the result on the chart.

In some embodiments, there is often a remainder from an uptick, downtick, trade at ask, or trade at bid. As an illustrative example, if the user defined input was set for 100 units of net directional volume to define a bar and the current count is at 95 up, then any additional volume greater than 5 units would result in a remainder. For example, if the next incoming volume came in at the magnitude of 25 in the up direction, a remainder of 20 units would be created. There are various ways of handling the new sum of 120 (95+25) which is in excess of the defined threshold of 100 with a remainder of 20. In a first preferred embodiment, bar plotting module could allocate the remainder or overage to stay with the old bar. Therefore, that particular bar would actually represent 120 units of net up volume. In an alternate preferred embodiment, the additional 20 units of volume may carried over by the bar plotting module and allocated to the next bar such that the new bar would start with that remainder count from the previous bar (in this case 20 units of volume). As a result, in this way of processing the bars, if the next bar was up biased, then it would only need 80 more units of positive volume to make the bar. If the market turned in the opposite direction, then it would take 120 units of negative biased net volume to make a new bar. Either of these computer implemented methods of handling remainder is encompassed in this invention, however, this detail has been left out of the FIG. 17 for the purposes of clarity. Importantly, the plotting methods behind the existing bar types that are discussed throughout this disclosure do not deal with remainders. As a result, this feature makes UDNTVBs further unique over other types of available bars and depending on the mode of processing, will further change the appearance of charts and bars in UDNTVBs charts.

According to a preferred embodiment of the present invention, UDNTVBs will feature certain characteristics that will both distinguish and be an improvement over other types of bars. In a preferred embodiment, the UDNTVB bars will be different from existing bars in two main categories.

First, there is a purposeful relationship between the interval of UDNTVBs and price movement. The count of ticks on which traditional tick bars are based is non-directional. In other words, the traditional tick bars have magnitude but no direction. In contrast, the UDNTVBs have both the magnitude and direction, like a vector. As the market trends, a graph using UDNTVBs will generate more bars than traditional time based bars, effectively smoothing the bars in trending situations. As the market consolidates, a graph using UDNTVBs will generate fewer bars than traditional time based bars. This will in many cases generate fewer whipsaw (or incorrect) trades than other bar types while the market is in consolidation. Furthermore, UDNTVBs, unlike traditional bars, will tend to close near their lows in a down trend and near their highs in an uptrend, generally having tails on the bars in the direction of the counter-trend (see FIGS. 3 and 4). This can make it possible to analyze the strength of a trend based on individual bar characteristics. Additionally, it can make candlestick bar type analysis more meaningful.

Second, there is a strong relationship between the price movement in price bars and the net count of volume within the bar. As a result, UDNTVBs can be used to make very specific cause and effect relationship determinations simply by glancing at a chart. This is possible because no other type of bar shows a specific measure of market pressure that is directly correlated to the range and/or price movement within the interval of the bar. Markets in breakout (coming out of consolidation) will tend to have large bars per unit of volume. Markets that are trending will tend to have smaller but smoother bars per unit of volume. Markets where a bar breaks out of a cluster can have a higher reliability of sustaining the breakout.

According to an embodiment of the present invention, the system for creating UDNTVB is comprised one or more communications means, one or more data stores, a processor, memory, and a bar plotting module. In alternate embodiments, the system for creating UDNTVB may be comprised of additional or fewer components. One of ordinary skill in the art would appreciate that there are many components that could be used in a system for creating UDNTVBs, and embodiments of the present invention are contemplated for use with any such component.

According to an embodiment of the present invention, bar plotting module is configured to generate UDNTVBs based on the assessment of market data. In a preferred embodiment, the bar plotting module will collect and analyze price, volume, and time information to track the performance of a given financial instrument that is being traded in the market. Based on this analysis, the bar plotting module will produce a chart that graphically represents the performance of that the given financial instrument. In the preferred embodiment, a trader or other user can use the chart that is created to more accurately predict a trend in the market than when compared to currently available charts and tracking systems. One of ordinary skill in the art would there are numerous parameters that could be monitored, tracked, and charted by the bar plotting module, and embodiments of the present invention are contemplated to utilize any such parameter.

According to an embodiment of the present invention, the communications means of the system may be, for instance, any means for communicating data, voice or video communications over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

### Exemplary Embodiment

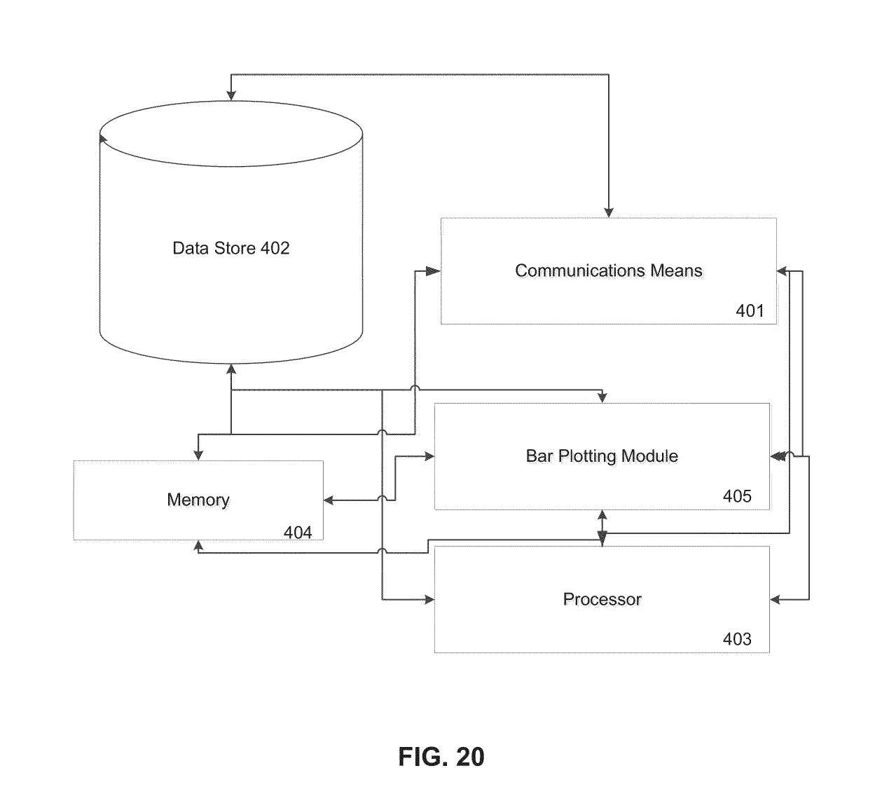

Turning to FIG. 20, according to an embodiment of the present invention, a system for generating and charting UDNTVBs is comprised of one or more communications means 401, one or more data stores 402, a processor 403, memory 404 and an bar plotting module 405. In alternate embodiments, the system may have additional or fewer components. One of ordinary skill in the art would appreciate that the system may be operable with a number of optional components, and embodiments of the present invention are contemplated for use with any such optional component.

### Illustrative Examples

Turning now to FIGS. 8-11, the various types of bars charts that are used to monitor and analyze market activity. Similarly, FIG. 7 represents a preferred embodiment of one form of UDNTVBs that will be used to make comparisons with currently available types of bar charts. Each of these charts (as shown in FIGS. 7-11) are arranged so as to fit the entire day's data onto each chart with similar resolutions. This normalizes the scale of each chart in order to make comparison possible. Furthermore, in any given interval of time each of the charts vary with respect to the number of bars that are occurring in the interval, the heights of the bars and where the bars close in their ranges.

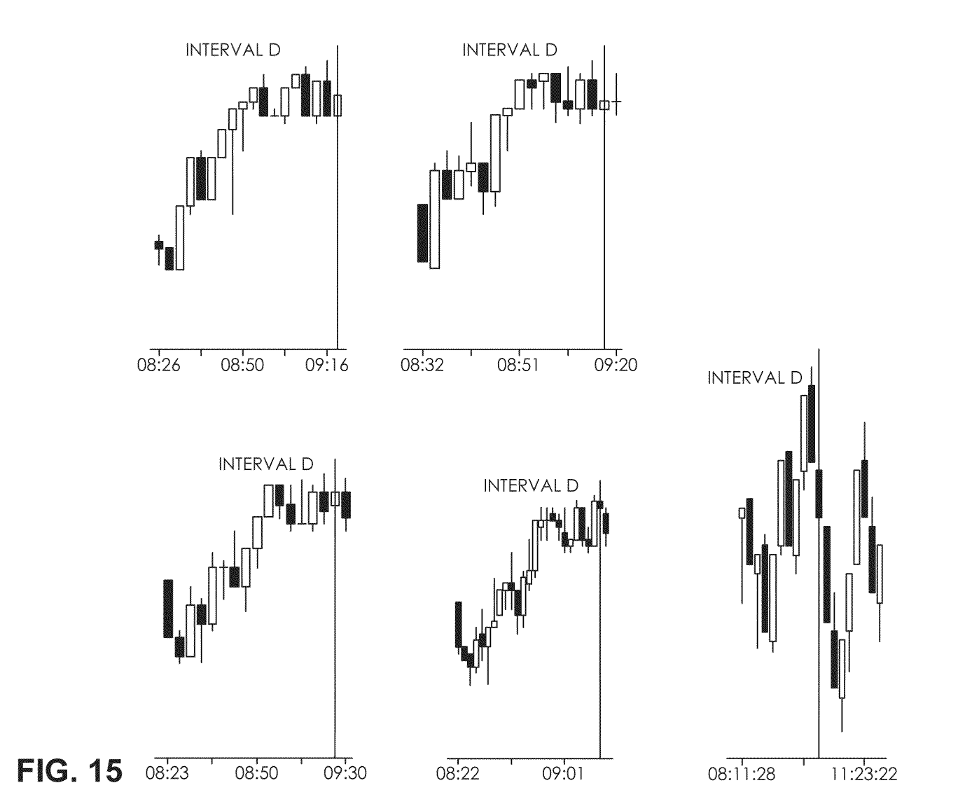

Turning now to FIGS. 12-15, each of these charts break out portions of FIGS. 7-11 into corresponding areas/intervals of overall up and down price movement (or trends) in order to illuminate some of the critical differences between all the different charts (i.e. bar types). This begins with FIG. 12 (labeled Interval A) and proceeds through FIG. 15 (labeled Interval D) and is used to summarize the key differences across these intervals with a particular focus (but not limited to) on where the bars are closing in their range as a function of the trend. For each of FIGS. 12-15 (i.e. Intervals A-D), there is one graph for each of the bar types, over the same market interval, including (in order from left to right and top to bottom, respectively) a UDNTVBs chart, a 295 tick chart, a 510 volume chart, a 132 seconds chart, and a 10 ticks range chart for the purposes of demonstrating the charting differences for each of the bar types.

Turning now to FIG. 12 (Interval A), an illustrative example of a market in which the direction of the trend is down. As summarized by the charts in FIGS. 16A-C: i) UDNTVBs chart: 20 bars close at Low out of 30 bars total; ii) 295 tick chart: 12 bars close at the Low out of 31 bars total; iii) 510 volume chart: 6 bars close at the Low out of 29 bars total; iv)132 seconds chart: no bars close at the Low out of 14 bars total; and v) 10 ticks range chart: 15 bars close at the Low out of 18 total. (Range bars, will by definition close at their lows or highs but are unrelated to volume, but will be included as a point of comparison by using range bars composed of 10 ticks of price height/range, or one point. This applies equally to FIGS. 13-15.). Comparing each of the bar types, it can be appreciated that the UDNVTBs generated approximately twice as many bars in this interval as the 132 seconds bars did. This interval, being the first part of the day, is our baseline interval. Furthermore, UDNTVBs generated similar number of bars to the other volume based bars but closed at the Low in the downtrend with a substantially improved frequency over the other volume based bar types. Additionally, UDNTVBs had increased range in the beginning of the trend, and smaller bars during the trend portions on the chart. Further, the descending bars became smaller as trends lost strength and larger as trends initiated.

Turning now to FIG. 13 (Interval B), an illustrative example of a market in which the direction of trend is up. As summarized by the charts in FIGS. 16A-C: i) UDNTVBs chart: 7 bars close at High out of 11 bars total; ii) 295 tick chart: 1 bar close at the High out of 17 bars total; iii) 510 volume chart: 7 bars close at the High out of 11 bars total; iv) 132 seconds chart: 1 bar close at the High out of 9 bars total, and v)10 ticks range chart: 8 bars close at the High out of 11 bars total. Comparing each of the bar types, it can be appreciated that the UDNVTBs generated more bars in this interval than the 132 seconds bars did. Furthermore, UDNTVBs generated similar number of bars to the other volume based bars but closed at the High in the uptrend with a substantially improved frequency over the other volume based bar types. Additionally, UDNTVBs had increased range in the beginning of the trend, and smaller bars during the trend portions on the chart. Finally, the descending bars became smaller as trends lost strength and were larger as trends initiated.

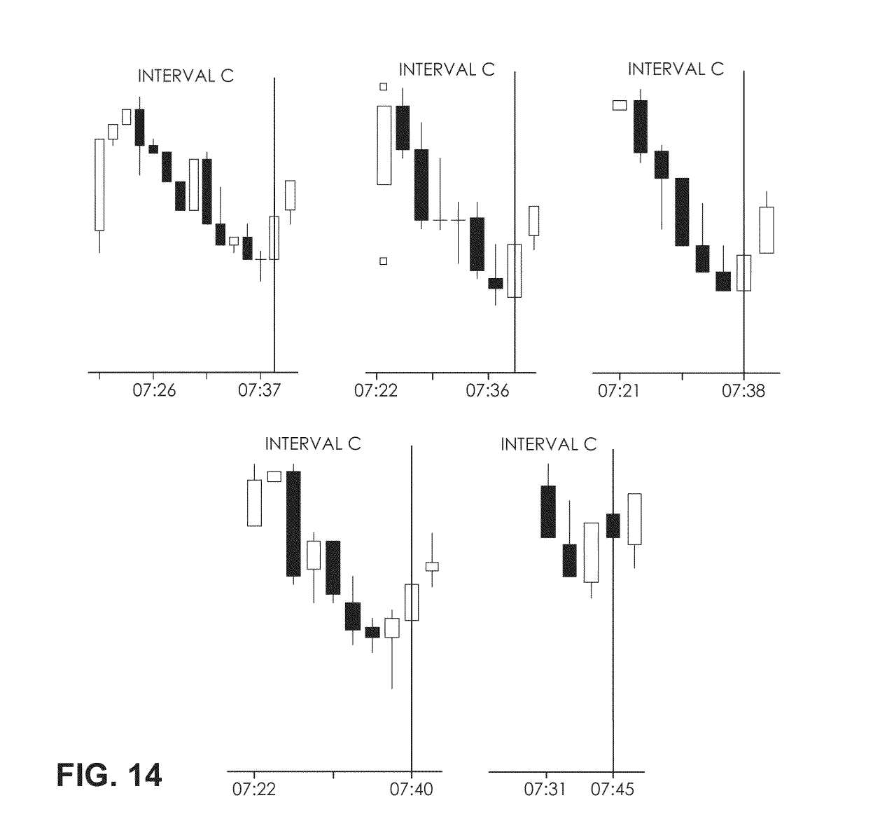

Turning now to FIG. 14 (Interval C), an illustrative example of a market in which the direction of the trend is down. As summarized by the charts in FIGS. 16A-C: i) UDNTVBs chart: 6 bars close at Low out of 10 bars total, ii) 295 tick chart: no bars close at the Low out of 6 total; iii) 510 volume chart: 3 bars close at the Low out of 5 total; iv) 132 seconds chart: no bars close at the Low out of 6 total; and v) 10 ticks range chart: 2 bars close at the Low out of 3 bars total. Comparing each of the bar types, it can be appreciated that the UDNVTBs generated more bars in this interval than the 132 seconds bars did. Additionally, UDNTVBs generated similar number of bars to the other volume based bars but closed at the Low in the downtrend with a substantially improved frequency over the other volume based bar types. Furthermore, UDNTVBs had increased range in the beginning of the trend, and smaller bars during the trend portions on the chart. Finally, the descending bars became smaller as trends lost strength and were larger as trends initiated.

Turning now to FIG. 15 (Interval D), an illustrative example of a market in which the direction of the trend is upward, but also consolidating. This upward trend is very slow and consolidates near the end of the trend just before the High. As summarized by the charts in FIGS. 16A-C: i) UDNTVBs chart: 10 bars close at the High out of 15 bars total; ii) 295 tick chart: 4 bars close at the High out of 14 total; iii) 510 volume chart: 3 bars close at the High out of 14 total; and iv) 132 seconds chart: 5 bars close at the High out of 22 total; and v) 10 ticks range chart: 4 bars close at the High out of 8 bars total. (Range bars, will by definition close at their lows or highs but are unrelated to volume, but we compare them here anyway using bars composed of 10 ticks of price height/range, or one point). Comparing each of the bar types, it can be appreciated that the UDNVTBs generated fewer bars in this interval than the 132 seconds bars did. This occurred specifically due to the consolidation in price towards the end of the trend. Additionally, the UDNTVBs generated similar number of bars to the other volume based bars but closed at the High in the uptrend with a substantially improved frequency over the other volume based bar types. Furthermore, UDNTVBs had increased range in the beginning of the trend, and smaller bars during the trend portions on the chart. Further, the descending bars became smaller as trends lost strength and were larger as trends initiated. Finally, when comparing UDNTBs to range based bars, it can be seen the range bars jump around erratically and are generally of a lower frequency than UDNTVBs.

It is important for traders to have charts that have adequate resolution to the market they are trading. More specifically, this means that the ratio of price movement to the overall trend is small enough for traders to extract a profit out of the existing price movement. On the other hand, it is equally important for traders not to have the resolution be so great that it creates indecision, whipsaw, or false breakouts when compared to the various bars available. UDNTVBs meet all of these needs more effectively than other available bars types. This is especially true because UDNTVBs relate price movement to the underlying directional volume that moves prices in commodity, stocks, futures, financial data charts, etc. (or in any type of data).

The illustrative examples contained herein, demonstrate that properties of UDNTVBs create unique and useful chart plots that cannot be found in other price bars both collectively or individually. In particular, UDNTVBs more consistently close at a High in an uptrend or the Low in a downtrend, specifically about 66% of the time across all tests. The other bars/chart types were highly variable across tests. In particular, other bar types closed at the High or Low in the direction of the trend between 12-32% of the time.

Variance is a statistical measure that tells us how measured data vary from the average value of the set of data; in other words, how consistent each data value from a given set is when compared to the average value of that set. UDNTVBs were highly consistent across different market trends/conditions with almost no variance at all. This means UDNTVBs behave the way they do in a statistically significant manner when compared to the other bar types tested. In the illustrative example that are summarized in FIGS. 16A-C, UDNTVBs had a variance of only 7.70 while the other bars had very large variance ranging from 90.62 in the case of time based bars to 434.10 in the case of the volume bars. Even the range bars, which by definition close at a High or Low, had a higher variance than the UDNTVBs. Range bars are unique in their own right due to their properties of having a fixed height but they were included in this series of tests for demonstration purposes. Only UDNTVBs had BOTH a High percentage (65% of the time) of closing at the High or Low in the direction of the trend AND a Low variance. Those versed in statistics will recognize this lack of variance is a good predictor of future tendencies and is statistically significant. A table (FIGS. 16A-C) is provided for comparison of the above summary of statistics. While UDNTBs are unique in more ways than discussed, the previously highlighted examples should suffice to demonstrate that UDNTVBs are in fact unique over other types of available bars.

According to an embodiment of the present invention, various formulas could be used In order to construct a UDNTVB from the available data. In some embodiments, the design is intended to correlate, for the user, the relationship between price movement and the directional volume behind it. Due to the fact that each bar has a fixed (user defined) unit of volume, the user can identify this relationship between buy/sell pressure and net price movement simply by noting the number of bars that are occurring in an interval. No other form of charting can accomplish this analysis.

This invention is best used (but not limited to) in the described context of plotting price charts in the many charting packages that are commercially available. According to an embodiment of the present invention, UDNTVBs have many uses. In a first preferred embodiment, UDNTVBs establish the clear relationship on a price bar between units of directional volume and units of price movement in a manner that correlates them. This method's efficacy is not limited to simple point to point relationships but also to overall structure of the market. As an illustrative example, many traders use what are called trend lines to determine if a price trend on a chart is failing and/or reversing. This is typically done by drawing a line along the bottoms of price points on an upward sloping series of price bars (or along the tops of price points on a downward sloping series of price bars). The trader will then enter the market based on the price breaking the trend line against the trend on which the line was based. When a trader does this on a minute (or time) based bar, the trader is plotting a slope that is based on time versus price slope. On the other hand, when a trader does this with charts made from UDNTVBs, the trader is doing so not just based on a failure (price moving through the line) of price in time, but on price per unit of some measure of directional volume. Due to the fact that UDNTVBs will elongate the interval between plot points on the X axis in trends and will contract it in consolidation, the price movement when the market reverses will often cross the trend-line much sooner than it would with the other bar types mentioned. This can make UDNTVBs a leading indicator over other methods based on other chart types. This same idea would also apply to moving averages and other very commonly used methods traders use to trigger their trades.

These are illustrative examples of a beneficial use for the present invention. There are countless other benefits to this sort of charting and analysis. Another preferred application of UDNTVBs occurs when price, for example, is moving upward for quite a few bars and then suddenly moves down more-or-less quickly in the span of a bar or two where the upward movement had been substantially more bars, than the downward movement. In cases like this, is highly unlikely to continue downward and the upward movement should resume. This is true for two reasons, 1) price trends may tend to persist especially where many UDNTVBs make up the trend (high volume, for example) and 2) selling on low volume would indicate market weakness. On UDNTVBs, this relationship will be wonderfully displayed as tall single bars (indicating large price movement for a small unit of net volume). Many other relationships can be discerned using computed bars and no other method of charting can make this claim.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for plotting price bars on a price chart, the system comprising:
a bar plotting module, comprising computer-executable code stored in non-volatile memory,
a processor, and
a communications means,
wherein said bar plotting module, said processor, and said communications means are operably connected and are configured to:
receive a volume threshold for a user, wherein said volume threshold is a threshold value for beginning a new user defined net tick volume bar;
receive one or more market trading information parameters, wherein said one or more market trading information parameters is selected from a group of market trading information parameters comprised of price data, tick data, volume data, and time interval data;
determine volume-price change association, wherein an up volume-price change association indicates increased buying activity and a down volume-price change association indicates increased selling activity;
analyze one or more market trading information parameters, wherein an incoming volume change is calculated based at least on a change in said volume data;
calculate updated bar volume, wherein said updated bar volume is based on current bar volume and said incoming volume change;
determine if said updated bar volume exceeds said volume threshold, wherein if said updated bar volume is less than said volume threshold an existing user defined net tick volume bar is updated to reflect current price data and said updated bar volume;
wherein if said updated bar volume exceeds said volume threshold said new user defined net tick volume bar is generated to display one or more volume bar information factors selected from a group of volume bar information factors comprising uptick trades, uptick volume, downtick trades, downtick volume, volume at ask trades, volume at ask volume, and volume at bid trades, and volume at bid volume;
plot said new user defined net tick volume bar on a chart, wherein said new user defined net tick volume bar is displayed to a user.

2. The system of claim 1, wherein said one or more market trading information parameters are received from a source of real time market data.

3. The system of claim 1, wherein said one or more market trading information parameters are received from a source of archived market data.

4. The system of claim 1, wherein said new user defined net tick volume bar is displayed as an open-high-low-close style bar.

5. The system of claim 1, wherein said new user defined net tick volume bar is displayed as a candlestick style bar.

6. A method for plotting price bars on a price chart for a financial instrument, the method comprising the steps of:
receiving a volume threshold for a user, wherein said volume threshold is a threshold value for beginning a new user defined net tick volume bar;
receiving one or more market trading information parameters, wherein said one or more market trading information parameters is selected from a group of market trading information parameters comprised of price data, tick data, volume data, and time interval data;
determining volume-price change association, wherein an up volume-price change association indicates increased buying activity and a down volume-price change association indicates increased selling activity;
analyzing one or more market trading information parameters, wherein an incoming volume change is calculated based at least on a change in said volume data;
calculating updated bar volume, wherein said updated bar volume is based on current bar volume and said incoming volume change;
determining if said updated bar volume exceeds said volume threshold, wherein if said updated bar volume is less than said volume threshold an existing user defined net tick volume bar is updated to reflect current price data and said updated bar volume;
wherein if said updated bar volume exceeds said volume threshold said new user defined net tick volume bar is generated to display one or more volume bar information factors selected from a group of volume bar information factors comprising uptick trades, uptick volume, downtick trades, downtick volume, volume at ask trades, volume at ask volume, and volume at bid trades, and volume at bid volume;
plotting said new user defined net tick volume bar on a chart, wherein said new user defined net tick volume bar is displayed to a user.

7. The method of claim 1, wherein said one or more market trading information parameters are received from a source of real time market data.

8. The method of claim 1, wherein said one or more market trading information parameters are received from a source of archived market data.

9. The method of claim 1, wherein said new user defined net tick volume bar is displayed as an open-high-low-close style bar.

10. The method of claim 1, wherein said new user defined net tick volume bar is displayed as a candlestick style bar.
